(19) United States
(12) Patent Application Publication
(10) Pub. No.: US 2025/0065503 A1
(43) Pub. Date: Feb. 27, 2025

(54) COLLISION PREDICTION METHOD, COLLISION PREDICTION DEVICE, AND WELDING SYSTEM

(71) Applicant: Kabushiki Kaisha Kobe Seiko Sho (Kobe Steel, Ltd.), Kobe-shi (JP)

(72) Inventors: Takumi NASU, Kobe-shi (JP); Akira OKAMOTO, Kobe-shi (JP); Tatsuya YOSHIMOTO, Kobe-shi (JP)

(73) Assignee: Kabushiki Kaisha Kobe Seiko Sho (Kobe Steel, Ltd.), Kobe-shi (JP)

(21) Appl. No.: 18/805,640

(22) Filed: Aug. 15, 2024

(30) Foreign Application Priority Data
Aug. 25, 2023 (JP) 2023-137311
Apr. 24, 2024 (JP) 2024-070863

(51) Int. Cl. B25J 9/16; B25J 11/00

(52) U.S. Cl. CPC B25J 9/1666; B25J 9/1605; B25J 11/005

(57) ABSTRACT

A collision prediction method for predicting a collision between a multi-joint robot and a nearby object includes a first acquisition step of acquiring configuration information of the robot and posture information of the robot; a second acquisition step of acquiring point cloud data including the robot and the nearby object; a classification step of classifying the point cloud data acquired in the second acquisition step into point cloud data corresponding to the robot and point cloud data corresponding to the nearby object, based on the configuration information of the robot and the posture information of the robot; and a prediction step of predicting a collision between the robot and the nearby object, based on a classification result obtained in the classification step.

### BACKGROUND OF THE INVENTION

### 1. Field of the Invention

The present invention relates to a collision prediction method, a collision prediction device, and a welding system.

### 2. Description of the Related Art

In the related art, when a robot performs motion for its operation target, the motion of the robot is controlled such that the robot does not collide with a peripheral device near the robot. Collision prediction can be not only performed during the motion of the robot but also used to generate a motion program for controlling the motion of the robot. Examples of the peripheral device near the robot include a positioner for holding the operation target, and an imaging device for imaging the operation target. During motion of the robot, a collision of an accessory of the robot, such as a cable, as well as the peripheral device, may also occur. It is desirable to also perform collision prediction for such an accessory and control the motion of the robot.

For example, Japanese Patent No. 6816070 discloses, as a method for collision prediction of a robot, a method for avoiding a collision by measuring the position of an object near the robot by using a three-dimensional sensor to create position data and storing the coordinates of the object with which the robot interferes.

In the method disclosed in Japanese Patent No. 6816070, the collision of only a tip portion of the robot is to be avoided. Therefore, it is difficult to predict a collision of a portion of the robot other than the tip portion or an accessory of the robot. In addition, accurate collision prediction is also desirable in a changing environment of a work place such as changing positions of the positioner. However, the method of the related art may cause a decrease in processing efficiency, an error in collision determination, or the like.

### SUMMARY OF THE INVENTION

Accordingly, it is an object of the present invention to provide a more accurate collision prediction method including collision prediction for an accessory of a robot.

To address the issues described above, an aspect of the present invention has the following configuration. A collision prediction method for predicting a collision between a multi-joint robot and a nearby object includes a first acquisition step of acquiring configuration information of the robot and posture information of the robot; a second acquisition step of acquiring point cloud data including the robot and the nearby object; a classification step of classifying the point cloud data acquired in the second acquisition step into point cloud data corresponding to the robot and point cloud data corresponding to the nearby object, based on the configuration information of the robot and the posture information of the robot; and a prediction step of predicting a collision between the robot and the nearby object, based on a classification result obtained in the classification step.

Another aspect of the present invention has the following configuration. A collision prediction device for predicting a collision between a multi-joint robot and a nearby object includes a first acquisition unit configured to acquire configuration information of the robot and posture information of the robot; a second acquisition unit configured to acquire point cloud data including the robot and the nearby object; a classification unit configured to classify the point cloud data acquired by the second acquisition unit into point cloud data corresponding to the robot and point cloud data corresponding to the nearby object, based on the configuration information of the robot and the posture information of the robot; and a prediction unit configured to predict a collision between the robot and the nearby object, based on a classification result obtained by the classification unit.

Another aspect of the present invention has the following configuration. A welding system includes a collision prediction device configured to predict a collision between a multi-joint robot and a nearby object, and a welding robot including the robot. The collision prediction device includes a first acquisition unit configured to acquire configuration information of the robot and posture information of the robot; a second acquisition unit configured to acquire point cloud data including the robot and the nearby object; a classification unit configured to classify the point cloud data acquired by the second acquisition unit into point cloud data corresponding to the robot and point cloud data corresponding to the nearby object, based on the configuration information of the robot and the posture information of the robot; and a prediction unit configured to predict a collision between the robot and the nearby object, based on a classification result obtained by the classification unit.

An aspect of the present invention enables more accurate prediction of a collision between a robot, including an accessory of the robot, and a nearby object.

### BRIEF DESCRIPTION OF THE DRAWINGS

FIG. 1 is a schematic diagram illustrating an example configuration of a welding system according to an embodiment of the present invention;

FIG. 2 is a block diagram illustrating an example configuration of a robot control device according to an embodiment of the present invention;

FIG. 3 is a block diagram illustrating an example functional configuration of a robot control device according to an embodiment of the present invention;

FIG. 4 is a conceptual diagram for describing a movable range of a robot according to an embodiment of the present invention;

FIG. 5A is an exemplary diagram for describing a method for classifying point cloud data according to an embodiment of the present invention;

FIG. 5B is an exemplary diagram for describing the method for classifying point cloud data according to the embodiment of the present invention;

FIG. 5C is an exemplary diagram for describing the method for classifying point cloud data according to the embodiment of the present invention;

FIG. 5D is an exemplary diagram for describing the method for classifying point cloud data according to the embodiment of the present invention;

FIG. 5E is an exemplary diagram for describing the method for classifying point cloud data according to the embodiment of the present invention;

FIG. 6A is an exemplary diagram for describing a method for classifying point cloud data according to an embodiment of the present invention;

FIG. 6B is an exemplary diagram for describing the method for classifying point cloud data according to the embodiment of the present invention;

FIG. 6C is an exemplary diagram for describing the method for classifying point cloud data according to the embodiment of the present invention;

FIG. 7A is an exemplary diagram for describing a method for classifying point cloud data according to an embodiment of the present invention;

FIG. 7B is an exemplary diagram for describing the method for classifying point cloud data according to the embodiment of the present invention;

FIG. 7C is an exemplary diagram for describing the method for classifying point cloud data according to the embodiment of the present invention;

FIG. 8A is an exemplary diagram for describing a collision prediction method according to an embodiment of the present invention;

FIG. 8B is an exemplary diagram for describing a collision prediction method according to an embodiment of the present invention;

FIG. 8C is an exemplary diagram for describing a collision prediction method according to an embodiment of the present invention; and

FIG. 9 is a flowchart of a collision prediction process according to an embodiment of the present invention.

### DESCRIPTION OF THE PREFERRED EMBODIMENTS

Embodiments of the present invention will be described hereinafter with reference to the drawings and the like. The following embodiments are embodiments for describing the present invention and are not intended to be interpreted as limiting the present invention. In addition, all the configurations described in each embodiment are not necessarily essential to achieve the advantages of the present invention. In the drawings, the same components are denoted by the same reference numerals to indicate the correspondence.

### First Embodiment

An embodiment of the present invention will be described hereinafter with reference to the drawings. The present embodiment will describe a welding system in which a multi-joint robot is used as a welding robot, by way of example but not limitation. The present invention is applicable to, for example, any robot that performs an operation such as gripping of an operation target.

### Configuration of Welding System

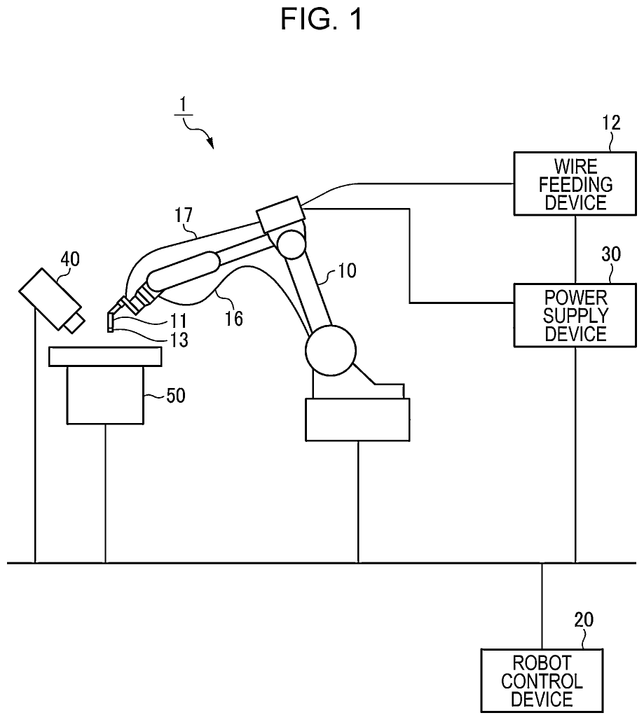

FIG. 1 illustrates an example configuration of a welding system 1 according to the present embodiment. The welding system 1 illustrated in FIG. 1 includes a welding robot 10, a robot control device 20, a power supply device 30, a camera 40, and a positioner 50. The welding robot 10 is constituted by a six-axis multi-joint robot, and a welding torch 11 is attached to a tip portion of the welding robot 10. The welding torch 11 is supplied with a welding wire 13 from a wire feeding device 12. The welding wire 13 is delivered from a tip of the welding torch 11 toward a welding point. The power supply device 30 supplies electric power to the welding wire 13. The robot control device 20 is configured to be capable of communicating with the welding robot 10 and its peripheral devices and controls various devices related to welding. The power supply device 30 is provided with a current sensor (not illustrated) that detects a welding current flowing from the welding wire 13 during welding to a workpiece (not illustrated) held by the positioner 50, and a voltage sensor (not illustrated) that detects an arc voltage between the welding wire 13 and the workpiece. The welding robot 10 is provided with accessories such as a cable 16 for a control signal and a cable 17 for the welding wire 13.

The power supply device 30 includes a processing unit (not illustrated) and a storage unit (not illustrated). The processing unit is constituted by, for example, a central processing unit (CPU). The storage unit is constituted by, for example, a volatile or nonvolatile memory such as a hard disk drive (HDD), a read only memory (ROM), or a random access memory (RAM). The processing unit executes a computer program for power supply control, which is stored in the storage unit, to control the electric power to be applied to the welding wire 13. The power supply device 30 is also connected to the wire feeding device 12, and the processing unit controls the speed and amount of feed of the welding wire 13.

The camera 40 is installed, for example, near the welding robot 10 and is used to image the surroundings of the welding robot 10. The camera 40 is configured to be capable of acquiring point cloud data serving as three-dimensional data. Examples of the camera 40 to be used include sensors such as a time-of-flight (ToF) camera, a stereo camera, and a light detection and ranging (LiDAR) sensor. The sensors described above have different characteristics and may thus be selectively used according to the measurement environment or the measurement target. In the present embodiment, the camera 40 is installed above the welding robot 10 and is configured to be capable of imaging the welding robot 10 located below the camera 40 and the surroundings of the welding robot 10. The installation position and the imaging range of the camera 40 are not limited thereto and may be set as desired such that the imaging range of the camera 40 includes a movable range of the welding robot 10 described below.

A ToF camera available as the camera 40 irradiates a measurement target with laser light and measures the reflected laser light with an imaging element to calculate a distance for each pixel. The distance that can be measured by the ToF camera is about several tens of centimeters to several meters. The stereo camera uses a plurality of images captured by a plurality of (e.g., two) cameras to calculate a distance from a parallax between the images. The distance that can be measured by the stereo camera is about several tens of centimeters to several meters. A LiDAR sensor irradiates the surroundings with laser light and measures the reflected laser light to calculate a distance. The distance that can be measured by the LiDAR sensor is about several tens of centimeters to several tens of meters.

A plurality of cameras 40 may be installed, and pieces of point cloud data imaged by the respective cameras 40 may be separately used to perform collision prediction described below. Alternatively, pieces of point cloud data imaged by respective ones of the plurality of cameras 40 may be subjected to coordinate transformation processing to integrate the pieces of point cloud data using unified coordinates. After that, collision prediction may be performed using the integrated pieces of point cloud data. The use of the plurality of cameras 40 suppresses or reduces blind spots and enables more accurate collision prediction.

The parts constituting the welding system 1 are communicably connected to each other by various wired/wireless communication methods. The connection may be performed using not a single communication method but a combination of multiple communication methods.

### Configuration of Robot Control Device

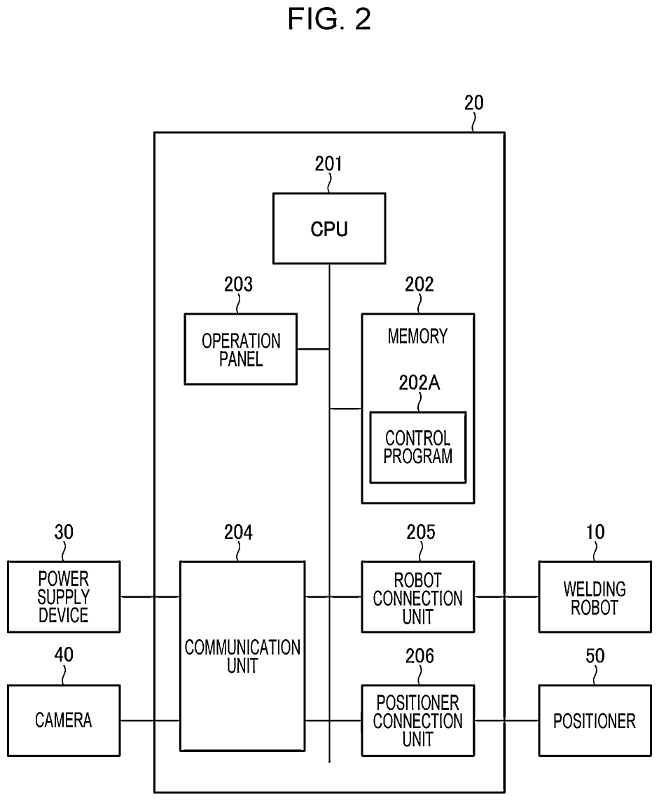

FIG. 2 illustrates an example configuration of the robot control device 20 that controls the motion of the welding robot 10. The robot control device 20 includes a CPU 201 for controlling the entire device, a memory 202, an operation panel 203 including a plurality of switches, a communication unit 204, a robot connection unit 205, and a positioner connection unit 206. The memory 202 is constituted by, for example, a volatile or nonvolatile storage device such as a ROM, a RAM, or an HDD. The memory 202 stores a control program 202A to be used for controlling the welding robot 10. The CPU 201 executes the control program 202A to control various motions of the welding robot 10 and the positioner 50. At this time, the robot control device 20 performs collision prediction by a collision prediction method described below and controls the posture, the motion trajectory, and the like of the welding robot 10 based on the prediction result. In the control of the welding robot 10, the robot control device 20 can identify posture information such as the position, coordinates, and angle of each part of the welding robot 10 at that time point.

The communication unit 204 includes a communication module for wired or wireless communication. The communication unit 204 is used for communication of data and signals to or from the power supply device 30, the camera 40, and so on. A communication method or standard used in the communication unit 204 is not limited. The communication unit 204 may use a plurality of communication methods in combination or use a different communication method for each device to be connected. For example, a current value of a welding current detected by the current sensor (not illustrated) or a voltage value of an arc voltage detected by the voltage sensor (not illustrated) is provided from the power supply device 30 to the CPU 201 via the communication unit 204. Further, point cloud data serving as three-dimensional data described below is acquired from the camera 40.

A drive circuit (not illustrated) of the welding robot 10 is connected to the robot connection unit 205. The CPU 201 outputs a control signal based on the control program 202A to the drive circuit (not illustrated) of the welding robot 10 via the robot connection unit 205.

A drive circuit (not illustrated) of the positioner 50 is connected to the positioner connection unit 206. The CPU 201 outputs a control signal based on the control program 202A to the drive circuit (not illustrated) of the positioner 50 via the positioner connection unit 206.

### Functional Configuration

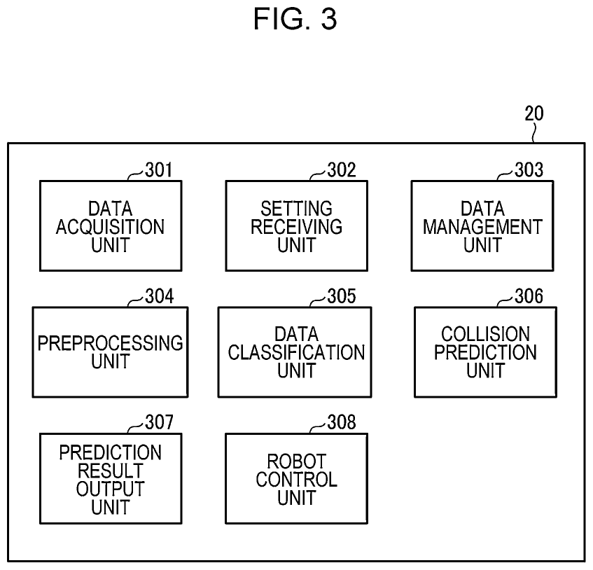

FIG. 3 is a block diagram illustrating an example functional configuration of the robot control device 20. The functions of the robot control device 20 may be implemented by, for example, the CPU 201 reading and executing the control program 202A. The illustrated functional configuration is an example, and other functions may further be included.

A data acquisition unit 301 acquires point cloud data imaged by the camera 40. The data acquisition unit 301 may notify the camera 40 of an imaging timing, an imaging setting, and the like of the point cloud data. At the imaging timing of the point cloud data, the data acquisition unit 301 further acquires posture information such as the position, coordinates, and angle of each of the parts constituting the welding robot 10 at the time point when the point cloud data is imaged. A setting receiving unit 302 receives various settings related to collision prediction according to the present embodiment. For example, the setting receiving unit 302 may be configured to be capable of receiving an imaging setting by the camera 40. A data management unit 303 holds and manages the point cloud data acquired by the data acquisition unit 301 and various settings received by the setting receiving unit 302. The data management unit 303 also manages device information such as a three-dimensional model indicating the shape of the welding robot 10 and a device configuration. The device information managed by the data management unit 303 may include configuration information specified by predefined specifications, such as the shape and structure of the welding robot 10, and posture information, such as the position, coordinates, and angle of each of the parts of the welding robot 10, which can change with motion.

A preprocessing unit 304 performs preprocessing on the acquired point cloud data. The preprocessing performed here may vary depending on the point cloud data to be used. Examples of the preprocessing include filter processing, outlier removal processing, clustering processing, and coordinate transformation processing. Accordingly, depending on the point cloud data, the preprocessing may be omitted. A data classification unit 305 performs a classification process on the point cloud data. The classification process will be described in detail below.

A collision prediction unit 306 performs collision prediction using data to which the classification process is applied by the data classification unit 305. The collision prediction will be described in detail below. A prediction result output unit 307 outputs a prediction result obtained by the collision prediction unit 306. The prediction result may be output so as to be used for control in the welding system 1 or may be output so as to be identifiable to an operator. A robot control unit 308 controls the motion of the welding robot 10 based on the prediction result of the collision prediction unit 306.

### Movable Range of Robot

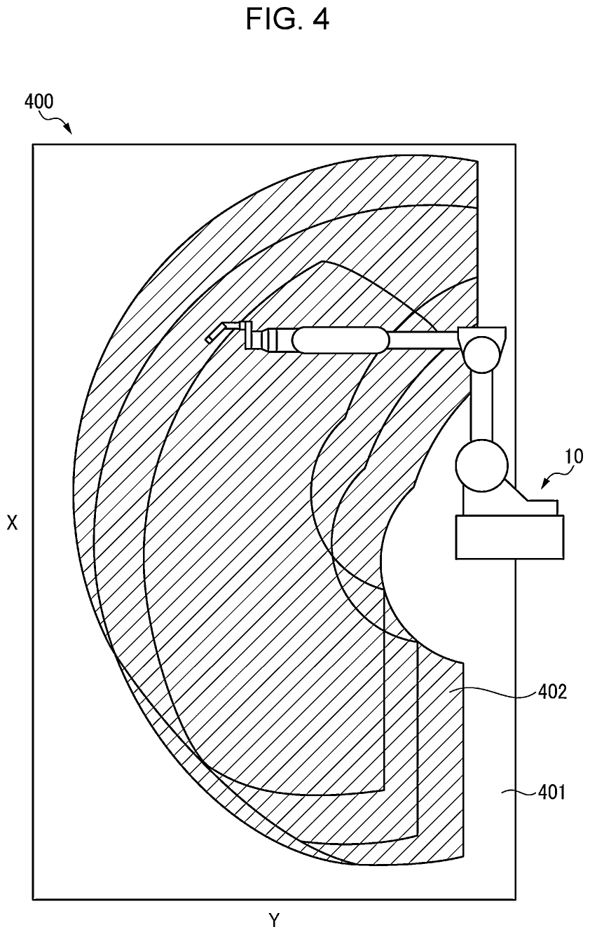

FIG. 4 is a conceptual diagram for describing a movable range of the welding robot 10. The multi-axis welding robot 10 occupies an area that changes according to the posture or the like of the welding robot 10. In FIG. 4, an area 400 in the XY plane is an imaging range of the camera 40. In the area 400, an area 402 indicated by hatching indicates a movable range within which the welding robot 10 is positioned in any posture. Accordingly, an area 401 indicating a range other than the area 402 indicates the outside of the movable range within which the welding robot 10 cannot be in any posture.

The positional relationship between the camera 40 and the welding robot 10 changes according to the installation position and orientation of the camera 40. For this reason, the movable range of the welding robot 10 as viewed from the camera 40 is appropriately defined according to the system configuration and the like.

In the present embodiment, in the preprocessing, at least part of the point cloud data positioned in the area 401, which is outside the movable range, is removed from the point cloud data acquired by the camera 40. That is, an area out of the movable range can be handled as an area where no collision occurs between the welding robot 10 and a nearby object. This prevents an error in collision prediction while reducing the processing load.

### Classification of Point Cloud Data

The following describes classification of point cloud data according to the present embodiment. In the present embodiment, to make the welding robot 10 distinguishable from any other object located near the welding robot 10, the point cloud data imaged by the camera 40 is classified into point cloud data corresponding to the welding robot 10 and point cloud data corresponding to another object, which are then used. Then, collision prediction is performed based on the classification of the point cloud data. The term “any other object” or “another object”, as used herein, is not limited to a peripheral device such as the positioner 50 and may include any nearby object with which a collision may occur, such as a floor and a shelf.

In the present embodiment, a plurality of point cloud data classification methods are executable. The classification methods have different accuracies and processing times and can thus be switched according to the purpose. The present embodiment describes an example in which four classifications are used, namely, classification based on a clustering method (also referred to as a “first classification method”), classification based on a difference between time-series point clouds (also referred to as a “second classification method”), classification for only the tip portion of the welding robot 10 (also referred to as a “third classification method”), and classification based on a difference in distance from a point cloud at a previous time (also referred to as a “fourth classification method”).

### First Classification Method

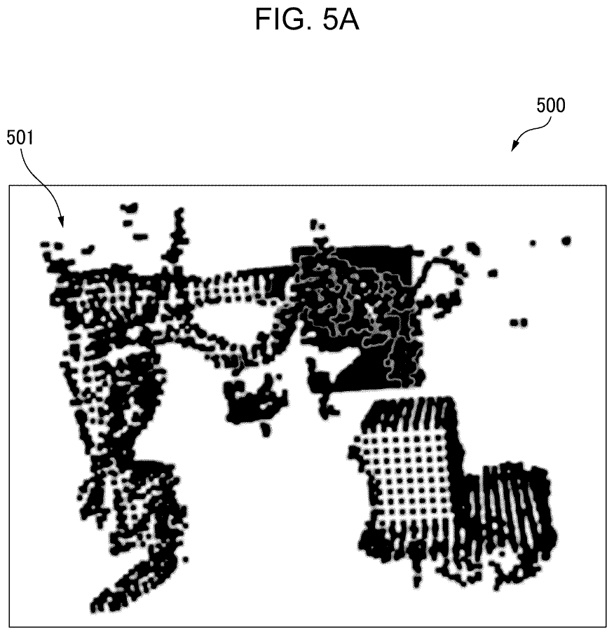

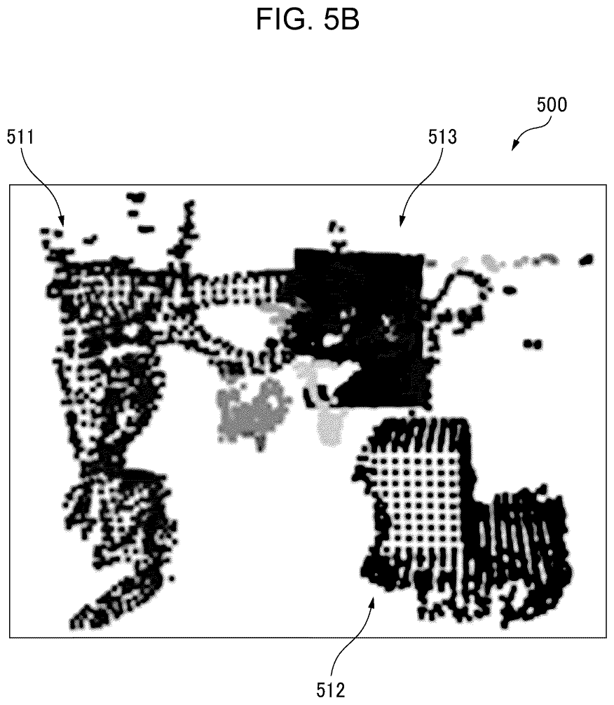

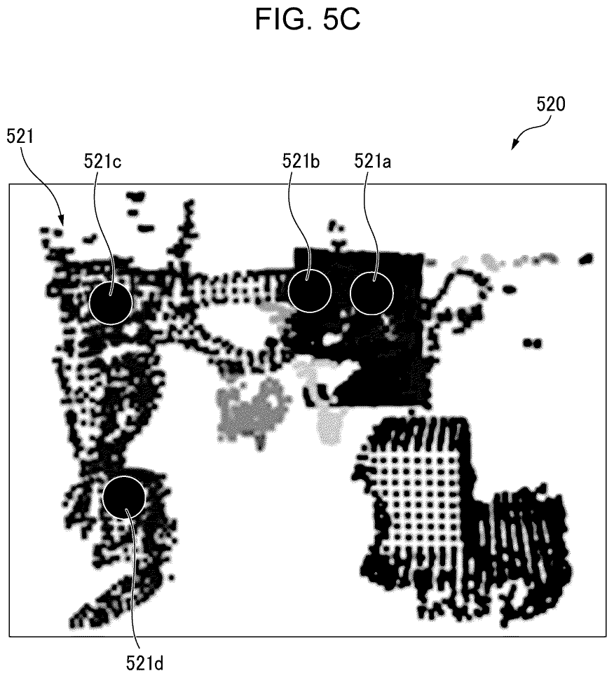

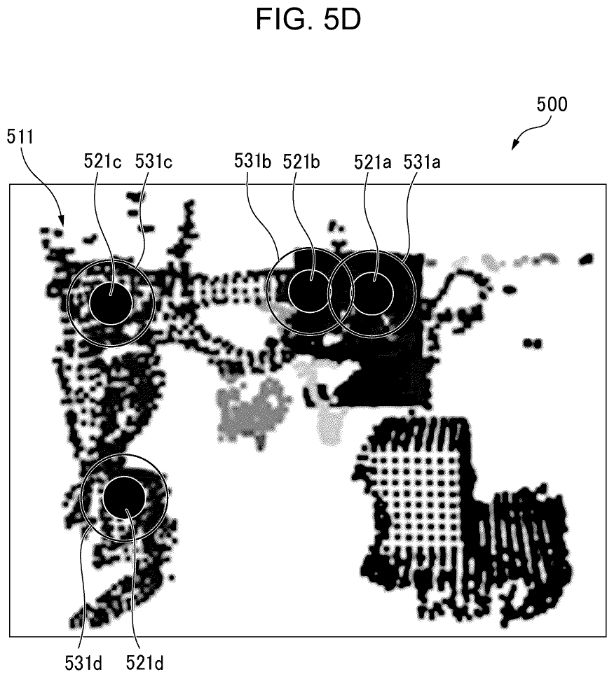

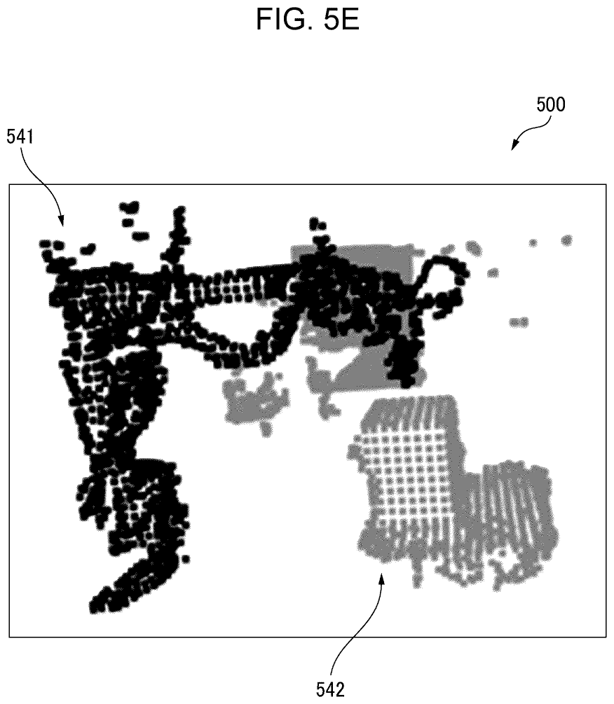

The flow of the first classification method will be described with reference to FIGS. 5A to 5E. FIG. 5A illustrates an example of point cloud data 500 including point cloud data 501 at a certain time point imaged by the camera 40. The point cloud data 501 illustrated in FIG. 5A is subjected to clustering by using a known method, for example, a density-based spatial clustering of applications with noise (DBSCAN) clustering method.

FIG. 5B illustrates an example of the point cloud data 500 subjected to the clustering processing. The point cloud data 500 is classified into a plurality of groups such as point cloud data groups 511, 512, and 513 and is illustrated such that the point cloud data groups 511, 512, and 513 can be identified from each other. Further, information corresponding to structural positions such as the positions of the joint portions of the welding robot 10 is set for the processing result illustrated in FIG. 5B. The structural positions such as the positions of the joint portions can be identified from information such as the specifications and posture of the welding robot 10, information on the three-dimensional model, and the like. FIG. 5C is a conceptual diagram illustrating a state in which information on the positions of the joint portions of the welding robot 10 is presented in a superimposed manner. FIG. 5C illustrates an example in which four pieces of information 521a, 521b, 521c, and 521d are set. Further, a point cloud located in a predetermined range from each of the pieces of information 521a, 521b, 521c, and 521d is identified. FIG. 5D illustrates an example in which ranges 531a, 531b, 531c, and 531d each having a predetermined radius are set for the pieces of information 521a, 521b, 521c, and 521d, respectively.

Then, all the clusters including the pieces of point cloud data included in the ranges 531a, 531b, 531c, and 531d are labeled as point cloud data indicating the welding robot 10. The other pieces of point cloud data are labeled as an object (any other object) other than the welding robot 10. As a result, as illustrated in FIG. 5E, the point cloud data 500 is classified into point cloud data 541 corresponding to the welding robot 10 and point cloud data 542 corresponding to another object.

The foregoing description has presented an example in which, as illustrated in FIG. 5C, point cloud data is identified by using the information on the positions of the joint portions of the welding robot 10. In addition, a desired point cloud (hereinafter referred to as a “simulation point cloud”) may further be set, and point cloud data of the welding robot 10 including the identified point cloud data and the simulation point cloud may be set. That is, the subsequent collision prediction is performed assuming that the welding robot 10 occupies an area larger than an actual area. For example, after the positions of a plurality of joint portions are set, the joint portions may be connected by a straight line, and any number of simulation point clouds may be linearly set around the joint portions at predetermined intervals. The straight line may correspond to, for example, a link of the welding robot 10.

Alternatively, any simulation point cloud may be set around the point cloud data corresponding to the welding robot 10, and point cloud data of the welding robot 10 to be identified may include the simulation point cloud. Such a simulation point cloud may be set in a predetermined shape corresponding to, for example, a cable or the like located behind an arm of the welding robot 10 in accordance with the posture of the welding robot 10. In this case, the size and the shape of the simulation point cloud to be set may be set based on predefined cable specifications, the posture of the arm, and the like.

Alternatively, any simulation point cloud may be set at a position located a predefined distance from the position of point cloud data corresponding to a specific part of the welding robot 10, and point cloud data of the welding robot 10 to be identified may include the simulation point cloud. Such a simulation point cloud may correspond to, for example, a cable or the like located below the arm of the welding robot 10. In this case, the size and the shape of the simulation point cloud to be set may be set based on predefined cable specifications.

### Second Classification Method

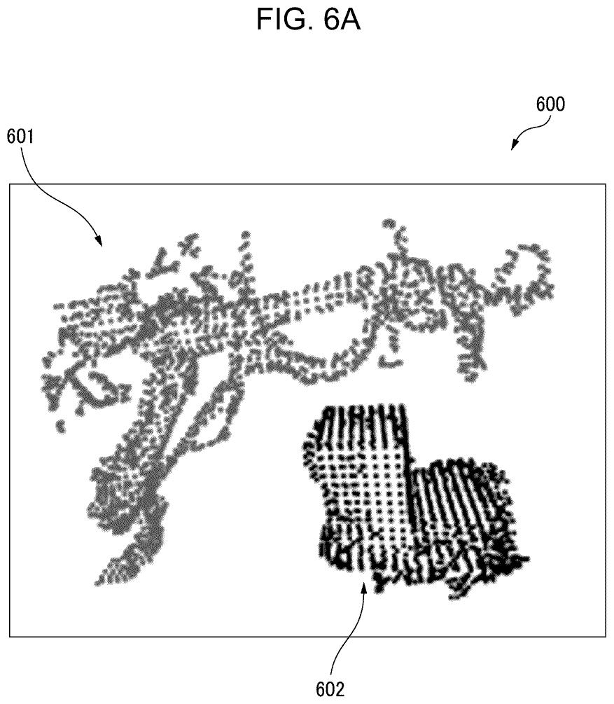

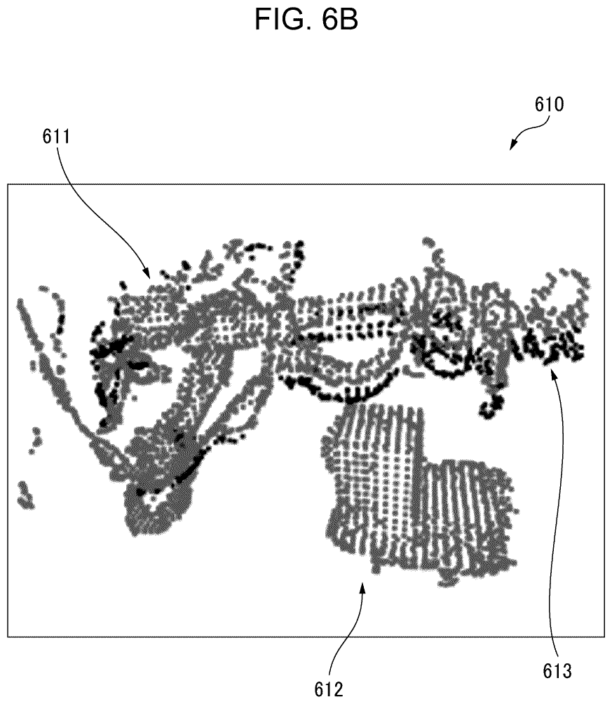

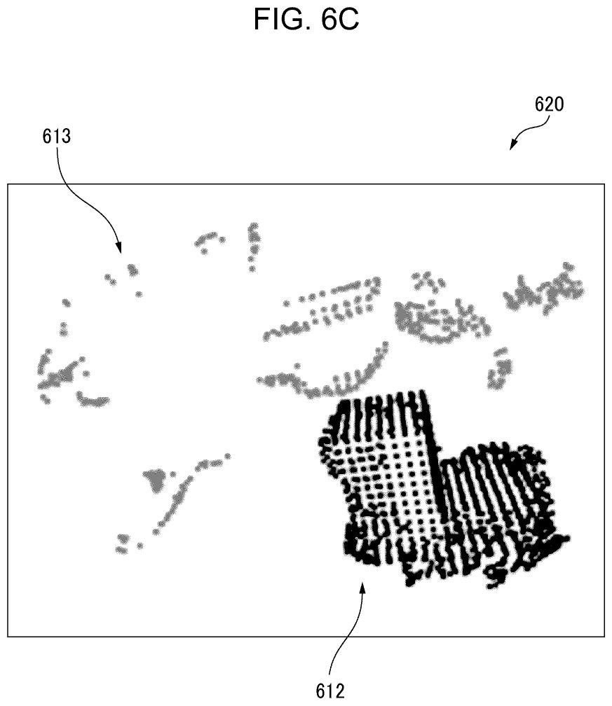

The second classification method will be described with reference to FIGS. 6A to 6C. First, as an initial state, point cloud data around the welding robot 10 is acquired and is subjected to clustering into point cloud data corresponding to the welding robot 10 and point cloud data corresponding to another object by using the first classification method. FIG. 6A illustrates a result of clustering of point cloud data 600 by the first classification method, and point cloud data 601 corresponding to the welding robot 10 and point cloud data 602 corresponding to another object are obtained. This is an initial setting.

Then, in the processing of point cloud data at a time point when collision prediction is performed (referred to as a “current time point”, for convenience), it is determined whether another object (here, the positioner 50) that may move has moved from the time point of the initial state. For example, it may be determined whether the positioner 50 has moved on the basis of a control signal or the like. When the other object is moving, the first classification method is used to perform classification of point cloud data at that time point. On the other hand, when the positioner 50 is not moving, the following process is performed.

In a point cloud included in the point cloud data in the initial setting and a point cloud included in the point cloud data at the current time point, the shortest distance between each point pair is detected, and a point pair between which the shortest distance is equal to or less than a threshold is deleted to extract only point cloud data that has changed. In FIG. 6B, point cloud data 611 indicates point cloud data that corresponds to the welding robot 10 and that is determined not to have changed from the initial setting. Point cloud data 613 indicates point cloud data that corresponds to the welding robot 10 and that is determined to have changed from the initial setting. Point cloud data 612 is point cloud data corresponding to another object and is assumed not to have changed from the initial setting.

FIG. 6C illustrates a state in which the point cloud data 611 determined not to have changed is deleted from the point cloud data illustrated in FIG. 6B. The resulting point cloud data is used to perform the subsequent collision prediction.

The time point of the initial state is not limited. For example, the initial state may be set as the start of operation of the welding system 1, or the initial state serving as a reference may be updated at regular intervals.

### Third Classification Method

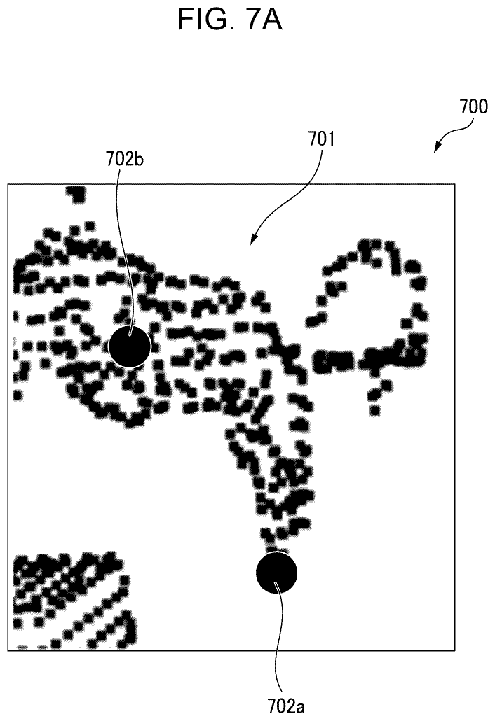

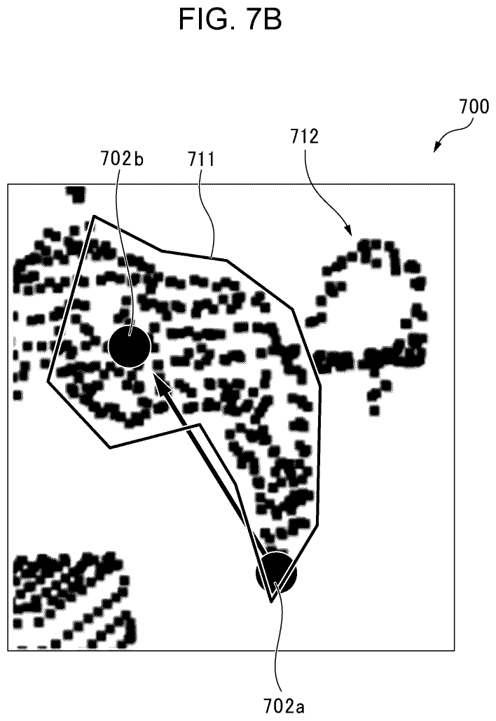

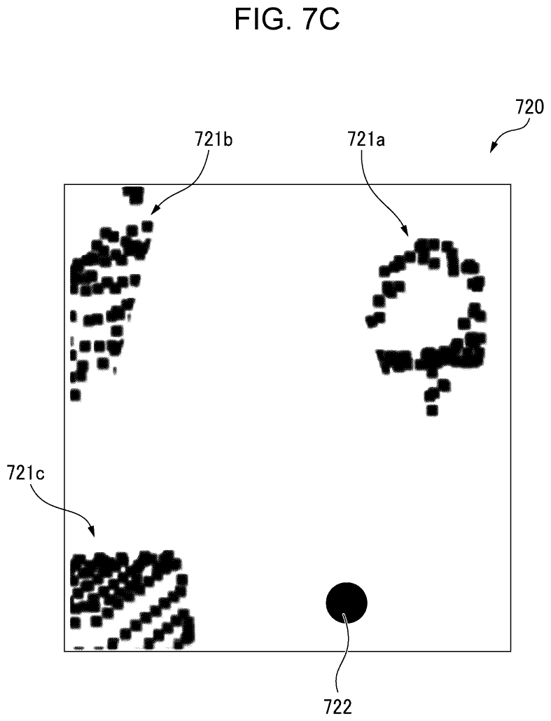

The third classification method will be described with reference to FIGS. 7A to 7C. First, the point cloud data of the entire welding system 1 as illustrated in FIG. 5A is acquired. In the acquired point cloud data, the tip portion of the welding robot 10 and the joint portion closest to the tip portion are identified based on the configuration information of the welding robot 10. FIG. 7A illustrates data 700 focusing on a portion around the tip portion of the welding robot 10 in the acquired point cloud data. Here, a point 702a corresponding to the tip portion of the welding robot 10 and a point 702b corresponding to the joint portion are identified.

Further, based on the positional relationship between the point 702a and the point 702b, a portion of a predefined three-dimensional model of the welding robot 10 is arranged. FIG. 7B illustrates an example in which the three-dimensional model is arranged, and an area 711 indicates a range within which the three-dimensional model is arranged. In contrast, point cloud data 712 corresponds to point cloud data that is not included in the area 711. The three-dimensional model arranged here may be a simple model instead of a detailed three-dimensional model.

FIG. 7C illustrates a state in which the point cloud data included in the area 711 illustrated in FIG. 7B is deleted. Here, point cloud data 722 that is included in the area 711 and corresponds to the position of the tip portion of the welding robot 10 remains undeleted. Point cloud data 721a, point cloud data 721b, and point cloud data 721c outside the area 711 are handled as point clouds corresponding to another object. Then, the point cloud data 722 corresponding to the tip portion of the welding robot 10 and the other point cloud data (i.e., the point cloud data 721a, the point cloud data 721b, and the point cloud data 721c) are used to perform the subsequent collision prediction. A range (an amount of point cloud data) to be handled as the tip portion of the welding robot 10 (corresponding to the point cloud data 722) is not limited and may be defined based on the size, the processing load, or the like of the welding robot 10.

### Fourth Classification Method

The fourth classification method will be described. As in the second classification method, first, as an initial state, point cloud data around the welding robot 10 is acquired and is subjected to clustering into point cloud data corresponding to the welding robot 10 and point cloud data corresponding to another object by using the first classification method. This is an initial setting. Then, the newly acquired point cloud data at the current time point is referred to, and it is determined whether the newly acquired point cloud data is closer to the point cloud data corresponding to the welding robot 10 in the initial setting or the point cloud data of the other object. Then, each piece of point cloud data at the current time point is classified as point cloud data of the closer one of the welding robot 10 and the other object. At this time, a threshold for the distance is set, and when the distance between the point cloud data at the current time point and the point cloud data of the welding robot 10 in the initial setting exceeds the threshold, the point cloud data at the current time point is handled as the point cloud data of the other object. After the determination of the point cloud data is completed, the initial setting is updated with the point cloud data at the current time point and is set as point cloud data at the previous time. Thereafter, when new point cloud data is acquired, the acquired point cloud data is compared with the point cloud data at the previous time, and classification is repeatedly performed.

In the fourth classification method, the initial setting may be set to include the simulation point cloud described above and may be compared with the point cloud data at the current time point. In this case, the simulation point cloud may also be included in the point cloud data at the previous time when the point cloud data at the previous time is set.

In the first classification method, the main body (including the tip portion and the joint portions) of the welding robot 10 and accessories (including cables) of the welding robot 10 are parts for which the collision is predictable. The distance between objects that can be classified is the longest among the four classification methods. The execution time is also the longest among the four classification methods. On the other hand, the first classification method enables classification even when the point cloud corresponding to the welding robot 10 is broken due to the presence of an obstacle or the like.

In the second classification method, the main body (including the tip portion and the joint portions) of the welding robot 10 and accessories (including cables) of the welding robot 10 are parts for which the collision is predictable. The distance between objects that can be classified is between the first classification method and the third classification method. The execution time is also between the first classification method and the third classification method. In the second classification method, the execution time increases when an object other than the welding robot 10 moves, whereas when an object other than the welding robot 10 does not move, the execution time is shorter than that in the first classification method because no clustering is used.

In the third classification method, the main body (the tip portion) of the welding robot 10 is a part for which the collision is predictable. The distance between objects that can be classified is the shortest among the four classification methods. The execution time is also the shortest among the four classification methods.

In the fourth classification method, the distance between the point cloud data of the welding robot 10 in the previous state and the point cloud data at the current time point is referred to. Thus, the fourth classification method is less susceptible to intrusion of a person or the like into the work area, movement of the positioner 50, or the like. The fourth classification method has a shorter execution time than the second classification method.

### Collision Prediction Method

In the present embodiment, collision prediction is performed using point cloud data classified by using the plurality of types of classification methods described above. In the present embodiment, three prediction methods are used, namely, a collision prediction method based on the shortest distance between point clouds (hereinafter also referred to as a “first prediction method”), a collision prediction method using a voxel overlap (hereinafter also referred to as a “second prediction method”), and a time series based collision prediction method (hereinafter also referred to as a “third prediction method”).

These collision prediction methods may be switched in accordance with the classification methods described above, or may be configured such that the operator can designate in advance which method to use. For example, the first prediction method can use the classification result of any of the first to fourth classification methods. The second prediction method can use the classification results of the first classification method, the second classification method, and the fourth classification method. The third prediction method can use the classification result of the first classification method.

### First Prediction Method

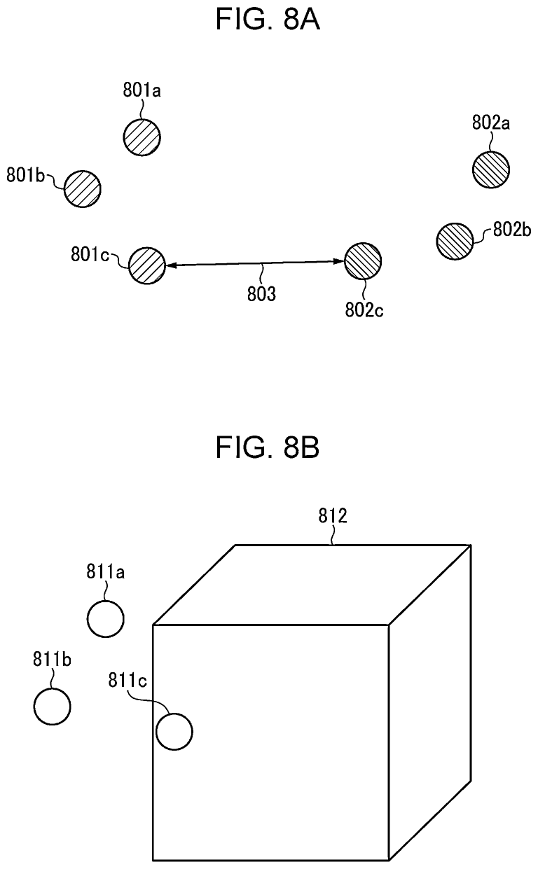

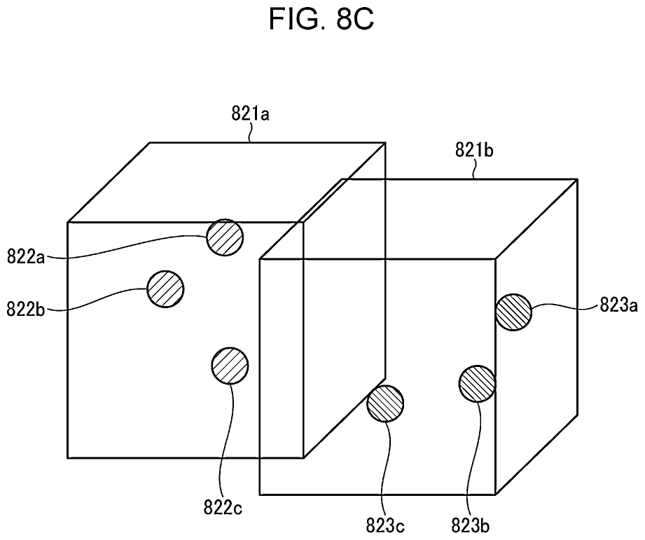

FIG. 8A is a diagram for describing the first prediction method, namely, a collision prediction method based on the shortest distance between point clouds. Here, points 801a, 801b, and 801c included in point cloud data corresponding to the welding robot 10 and points 802a, 802b, and 802c included in point cloud data corresponding to another object are illustrated as a result of the classification process.

In the first prediction method, first, a threshold for a distance for determining that a collision is about to occur is set. The threshold may be defined in advance based on the motion speed of the welding robot 10, the interval of the collision prediction process, and so on. Then, in the point cloud data, the shortest distance between points is derived. In the example illustrated in FIG. 8A, the distance between the point 801c included in the point cloud data of the welding robot 10 and the point 802c included in the point cloud data of the other object is derived as a shortest distance 803. The shortest distance, as used here, is a distance in a three-dimensional space. The shortest distance may be derived by any method, for example, a known k-d tree method. When the shortest distance 803 is equal to or less than the threshold, it is determined that a collision is about to occur.

The distance between point clouds is not derived using a single shortest distance, but may be derived using, for example, an average of a plurality of highest-ranked distances in the ascending order among the distances between point clouds. Alternatively, the shortest distance may be derived after removal of an outlier in the point clouds.

As described above, the simulation point cloud may be included in the point cloud data corresponding to the welding robot 10, and the shortest distance may be derived. At this time, in the point cloud data corresponding to the welding robot 10 including the simulation point cloud, a point cloud in any range may be removed to increase the processing speed.

Further, the point clouds for which the shortest distance is to be derived may be selected based on a movement direction of the welding robot 10. The movement direction of the welding robot 10 can be identified in accordance with the direction of welding, the posture of the welding robot 10, and so on. For example, the range for deriving the shortest distance between the point cloud data of the welding robot 10 and the point cloud data of another object may be identified by the following process flow.

(i) A movement vector of a tip position (e.g., a tool center point (TCP)) of the welding robot 10, a joint position of the welding robot 10, or a point cloud (including a simulation point cloud) of a link in the welding robot 10 is calculated. For example, the movement direction of the welding robot 10 may be acquired with reference to teaching data. Alternatively, the difference between the current position vector and the past position vector may be calculated to calculate the movement vector. The position of the welding robot 10 used as a reference to calculate the movement vector is not limited to that described above, and may further include any other part of the welding robot 10.

(ii) A three-dimensional shape having a predefined size or shape is arranged along the movement vector calculated in (i). For example, a cylinder, which is a predefined three-dimensional shape, may be arranged in the direction of the movement vector with the TCP at the current time point as the center of a bottom surface of the cylinder. Alternatively, a rectangular parallelepiped, which is a predefined three-dimensional shape, may be arranged so as to be parallel to the link with one point of the simulation point cloud of the link at the current time point as the center of a bottom surface of the rectangular parallelepiped. The three-dimensional shape used here is not limited to a cylinder or a rectangular parallelepiped and may be any shape. In addition, the configuration of the three-dimensional shape may be changed in accordance with the part of the welding robot 10 in which the three-dimensional shape is to be arranged.

(iii) Point cloud data located in the three-dimensional shape arranged in (ii) is extracted from the point cloud data corresponding to the other object, and is set as a target for deriving the shortest distance from the point cloud data corresponding to the welding robot 10.

The method as described above can reduce the point cloud data to be used for collision prediction and enables an increase in processing speed.

### Second Prediction Method

FIG. 8B is a diagram for describing the second prediction method, namely, a collision prediction method using a voxel overlap. Here, points 811a, 811b, and 811c included in point cloud data corresponding to the welding robot 10 are illustrated as a result of the classification process. In addition, a voxel 812 defined based on point cloud data corresponding to another object is illustrated.

In the second prediction method, first, a threshold for the number of points of the welding robot 10 and the size of a voxel based on point cloud data of another object are set to determine that a collision is about to occur. The threshold may be defined in advance based on the motion speed of the welding robot 10, the interval of the collision prediction process, and so on. The size of the voxel may also be defined in advance according to the safety of collision prediction and so on. Even when the distance between the welding robot 10 and the other object is larger as the size of the voxel increases, it can be determined that a collision is about to occur.

Then, the point cloud data of the other object is voxelized based on the set size. As a result, the voxel 812 illustrated in FIG. 8B is obtained. Then, the number of points corresponding to the welding robot 10 overlapping with the voxel 812 is counted. In the example illustrated in FIG. 8B, the point 811c overlaps with the voxel 812, and the number of overlaps is “1”. When the number of overlaps is equal to or greater than a set threshold, it is determined that a collision is about to occur.

The voxelization is not limited to that described above. The point cloud data corresponding to the welding robot 10 may be voxelized, or both the point cloud data corresponding to the welding robot 10 and the point cloud data corresponding to the other object may be voxelized.

FIG. 8C illustrates an example in which both point cloud data corresponding to the welding robot 10 and point cloud data corresponding to another object are voxelized. Points 822a, 822b, and 822c are points included in the point cloud data corresponding to the welding robot 10, and a voxel 821a is set accordingly. Points 823a, 823b, and 823c are points included in the point cloud data corresponding to the other object, and a voxel 821b is set accordingly.

As illustrated in the example illustrated in FIG. 8C, in collision prediction using a voxel of the point cloud data corresponding to the welding robot 10 and a voxel of the point cloud data corresponding to the other object, first, it is determined whether the voxels overlap. When the voxels overlap, the numbers of points included in the respective voxels are counted, and an evaluation value is derived based on the numbers of points. When the evaluation value is equal to or greater than a preset threshold, it may be determined that a collision is about to occur. The evaluation value may be derived by any method. For example, the evaluation value may be the product of the numbers of points included in the respective voxels. In the example illustrated in FIG. 8C, the evaluation value may be derived by (the number of points included in the voxel 821a: 3)×(the number of points included in the voxel 821b: 3)=(the evaluation value: 9).

### Third Prediction Method

The third prediction method, namely, a time series based collision prediction method, will be described. First, a threshold for the point cloud of the welding robot 10 is set to determine that a collision is about to occur. The threshold may be defined in advance based on the motion speed of the welding robot 10, the interval of the collision prediction process, and so on.

Further, the number of points of the point cloud data corresponding to the welding robot 10 when the welding robot 10 is in initial posture is held. Then, the number of points of the point cloud data corresponding to the welding robot 10 at a time point when collision prediction is performed (referred to as a “current time point”, for convenience) is acquired. Then, the difference between the number of points included in the point cloud data corresponding to the welding robot 10 in the initial posture and the number of points included in the point cloud data corresponding to the welding robot 10 at the current time point is calculated. When the difference is equal to or greater than a preset threshold, it is determined that a collision is about to occur. After the determination is made, the held number of points of the point cloud data is updated with the number of points of the point cloud data corresponding to the welding robot 10 at the current time point. The subsequent collision prediction process is repeatedly performed using the updated value.

In the first prediction method, a collision prediction position is easily checked, but the processing execution time tends to increase as the number of points of the point cloud data corresponding to the welding robot 10 increases. In the second prediction method, a collision prediction position is less easily checked than in the first prediction method, but the processing execution time can be reduced.

In the third prediction method, a collision prediction position is easily checked, and the processing execution time can be reduced. The third prediction method has another characteristic in which a slight misclassification of point clouds could be overcome. In the third prediction method, accordingly, even when an erroneous determination is made in the first classification method, the increase or decrease in the number of points is small, and the influence of the classification accuracy on the determination result can thus be suppressed. The third prediction method is preferably applied to another object having a size equal to or greater than a predetermined size. In addition, the number of points of the point cloud data corresponding to the welding robot 10 is expected to change greatly depending on the change in the posture of the welding robot 10. Thus, it is preferable to switch whether to apply the third prediction method, in accordance with the change in the posture of the welding robot 10.

### Process Flow

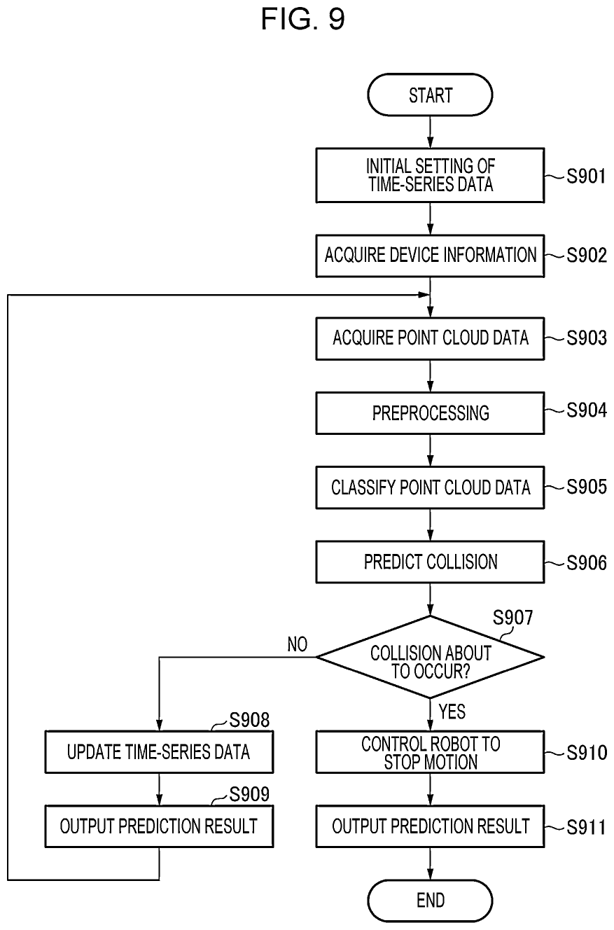

FIG. 9 is a flowchart of a collision prediction process for the welding robot 10 according to the present embodiment. This process flow may be implemented by, for example, the CPU 201 of the robot control device 20 reading and executing the control program 202A. This process flow may be started at the same time as the start of the motion of the welding system 1. It is assumed that the welding robot 10 continuously moves, in parallel with this process flow, in accordance with any motion program.

In S901, the robot control device 20 performs initial setting of time-series data. In this processing, initial setting used in the second classification method or the like described above is performed. More specifically, the classification result of point cloud data of the welding robot 10 in basic posture and point cloud data of another object is set. The processing of S901 may be omitted depending on a method used in the subsequent classification process.

In S902, the robot control device 20 acquires device information. For example, information on a three-dimensional model or a device configuration of the welding robot 10, which is set in advance, posture information or position information of the welding robot 10 in real time, position information of the positioner 50, or the like may be acquired.

In S903, the robot control device 20 acquires point cloud data imaged by the camera 40.

In S904, the robot control device 20 applies preprocessing to the point cloud data acquired in S903. Examples of the preprocessing include coordinate transformation processing, downsampling processing, out-of-range point cloud removal processing, and outlier removal processing. In the coordinate transformation processing, for example, coordinate transformation is performed between different coordinate systems such as the camera coordinate system and the system coordinate system. When pieces of point cloud data imaged using a plurality of cameras 40 are integrated for use, coordinate transformation may be performed such that the pieces of point cloud data correspond to each other. In the downsampling processing, the acquired point cloud data is reduced to a desired resolution in accordance with the processing load or the like. In the out-of-range point cloud removal processing, for example, as illustrated in FIG. 4, the area 401 out of the range within which the welding robot 10 moves is to be the target for collision prediction, and thus the point cloud data in the area 401 is removed from the acquired point cloud data. In the outlier removal processing, a point having a value exceeding a predetermined threshold is removed from the point cloud data. The types of preprocessing are examples, and other types of processing may be executed. In addition, depending on the point cloud data to be acquired, all or part of the preprocessing may be omitted.

In S905, the robot control device 20 performs a classification process on the target point cloud data. As described above, in the present embodiment, the four classification methods are available, and which method to use may be determined by using any classification method set by the operator or may be selectively switched by the robot control device 20 in accordance with the processing load, the motion speed of the welding robot 10, the content of the motion of the welding robot 10, or the like.

In S906, the robot control device 20 performs collision prediction on the basis of the result of the classification performed in S905. As described above, in the present embodiment, the three prediction methods are available, and which method to use may be selectively switched in accordance with the classification method used in S905. At this time, any prediction method set by the operator may be used, or the prediction method to be used may be switched by the robot control device 20 in accordance with the processing load, the motion speed of the welding robot 10, the content of the motion of the welding robot 10, or the like.

In S907, the robot control device 20 determines whether a collision is about to occur, on the basis of the prediction result obtained in S906. If a collision is about to occur (S907: YES), the process of the robot control device 20 proceeds to S910. On the other hand, if a collision is not about to occur (S907: NO), the process of the robot control device 20 proceeds to S908.

In S908, the robot control device 20 updates the time-series data on the basis of the processing result obtained in S905 or S906. Like the processing of S901, the processing of S908 may be omitted depending on the classification process to be used. Then, the process of the robot control device 20 proceeds to S909.

In S909, the robot control device 20 outputs the prediction result obtained in S906. The prediction result may include, for example, a distance between the welding robot 10 and another object and information on the processed point cloud data in addition to information indicating that a collision is not about to occur. The prediction result may be output by any method. The prediction result may be notified to a user via the operation panel 203 or the like or may be stored in the memory 202 as history information. Then, the process of the robot control device 20 returns to S903, and the subsequent processing is repeatedly performed.

In S910, the robot control device 20 determines that a collision is about to occur, and controls the welding robot 10 to stop the motion of the welding robot 10. Then, the process of the robot control device 20 proceeds to S911.

In S911, the robot control device 20 outputs the prediction result obtained in S906 and information indicating that the welding robot 10 is stopped on the basis of the prediction result. The prediction result may include, for example, a distance between the welding robot 10 and another object and information on the processed point cloud data in addition to information indicating that a collision is about to occur. The prediction result may be output by any method. The prediction result may be notified to the user via the operation panel 203 or the like or may be stored in the memory 202 as history information. Then, this process flow ends.

Even during the process flow described above, when the motion of the welding robot 10 is completed, the process flow may end.

As described above, the present embodiment enables more accurate prediction of a collision between a robot, including an accessory of the robot, and a nearby object.

### Other Embodiments

The present invention can also be implemented by processing for supplying a program or an application for implementing one or more functions of the embodiment described above to a system or device via a network, a storage medium, or the like and causing one or more processors in a computer of the system or device to read and execute the program.

The present invention may be implemented by a circuit that implements one or more functions. Examples of the circuit that implements one or more functions include an application specific integrated circuit (ASIC) and a field programmable gate array (FPGA).

As described above, the following are disclosed herein.

(1) A collision prediction method for predicting a collision between a multi-joint robot (10, for example) and a nearby object (50, for example), the collision prediction method including:
a first acquisition step of acquiring configuration information of the robot and posture information of the robot;
a second acquisition step of acquiring point cloud data including the robot and the nearby object;
a classification step of classifying the point cloud data acquired in the second acquisition step into point cloud data corresponding to the robot and point cloud data corresponding to the nearby object, based on the configuration information of the robot and the posture information of the robot; and
a prediction step of predicting a collision between the robot and the nearby object, based on a classification result obtained in the classification step.

This configuration enables more accurate prediction of a collision between a robot, including an accessory of the robot, and a nearby object.

(2) The collision prediction method according to (1), wherein
in the classification step, at least one of a first classification method, a second classification method, a third classification method, or a fourth classification method is executable, the first classification method being a method of performing clustering on the point cloud data acquired in the second acquisition step and classifying the point cloud data into the point cloud data corresponding to the robot and the point cloud data corresponding to the nearby object, based on a result of the clustering and a position of the robot, the position of the robot being identified by the configuration information and the posture information acquired in the first acquisition step;
the second classification method being a method of acquiring first point cloud data corresponding to the robot from the point cloud data acquired in the second acquisition step by using the first classification method, comparing the first point cloud data with second point cloud data stored in advance, removing, from the first point cloud data, a point cloud for which a shortest distance from the second point cloud data is equal to or less than a predetermined threshold to obtain point cloud data, and classifying the obtained point cloud data as the point cloud data corresponding to the robot,
the third classification method being a method of predicting a position of a tip portion of the robot in the point cloud data acquired in the second acquisition step, based on the configuration information and the posture information, and classifying, as the point cloud data corresponding to the robot, a point cloud corresponding to the tip portion of the robot among point clouds overlapping with a three-dimensional model of the robot when the three-dimensional model of the robot is arranged at the predicted position,
the fourth classification method being a method of acquiring first point cloud data corresponding to the robot from the point cloud data acquired in the second acquisition step by using the first classification method, comparing the first point cloud data with past point cloud data corresponding to the robot and past point cloud data corresponding to the nearby object, and classifying the first point cloud data as closer point cloud data of the past point cloud data corresponding to the robot and the past point cloud data corresponding to the nearby object.

This configuration allows the point cloud data to be classified by using a plurality of types of classification methods, thereby making it possible to achieve more appropriate collision prediction according to the processing load or the processing accuracy.

(3) The collision prediction method according to (2), further including a determination step of determining whether the nearby object has moved, wherein
in the classification step, the first classification method is used when it is determined that the nearby object has moved, and the second classification method is used when it is determined that the nearby object has not moved.

This configuration makes it possible to perform collision prediction by switching among the classification methods in accordance with the motion of a peripheral device located near the robot.

(4) The collision prediction method according to (2) or (3), wherein
in the prediction step, at least one of a first prediction method, a second prediction method, or a third prediction method is executable,
the first prediction method being a method of predicting the collision by comparing a shortest distance between the point cloud data corresponding to the robot and the point cloud data corresponding to the nearby object with a predetermined threshold,
the second prediction method being a method of predicting the collision by setting at least one of the point cloud data corresponding to the robot or the point cloud data corresponding to the nearby object as a voxel and determining an overlap, based on the voxel,
the third prediction method being a method of predicting the collision, based on a difference in the number of points between current point cloud data corresponding to the robot and previous point cloud data corresponding to the robot.

This configuration allows collision prediction using a plurality of types of classification methods for point cloud data classified by using a plurality of classification methods, thereby making it possible to achieve more appropriate collision prediction in accordance with the processing load or the processing accuracy.

(5) The collision prediction method according to any one of (1) and (4), further including a preprocessing step of performing predetermined preprocessing on the point cloud data acquired in the second acquisition step, wherein
the predetermined preprocessing includes a process of removing point cloud data located out of a movable range of the robot, and
the classification step classifies the point cloud data on which the predetermined preprocessing is performed in the preprocessing step.

This configuration makes it possible to execute collision prediction with higher accuracy and low processing load, focusing on the range within which the collision of the robot may occur.

(6) The collision prediction method according to any one of (1) and (5), further including an installation step of installing a simulation point cloud for point cloud data classified as the point cloud data corresponding to the robot in the classification step, wherein
the prediction step predicts a collision between the robot and the nearby object by using point cloud data including the simulation point cloud installed in the installation step, and
the simulation point cloud is installed in a straight line connecting a position of a tip of the robot and a position of a joint of the robot or is installed in a predetermined shape with respect to a position corresponding to a predetermined part of the robot.

This configuration makes it possible to execute collision prediction in consideration of an area corresponding to a desired member or part in addition to the point cloud data corresponding to the robot.

(7) The collision prediction method according to any one of (1) to (6), further including:
a step of acquiring information on a movement direction of a predetermined point on the robot; and
an extraction step of setting a predefined range for the point cloud data corresponding to the robot, the predefined range being defined in advance to extend along a movement direction of the robot with respect to the predetermined point, and extracting point cloud data corresponding to the nearby object within the predefined range, wherein
the prediction step predicts a collision between the robot and the nearby object by using the point cloud data corresponding to the nearby object extracted in the extraction step and the point cloud data corresponding to the robot.

This configuration makes it possible to perform processing on limited point cloud data to be used for the prediction in consideration of the movement direction of the robot, and can reduce the amount of point cloud data to be used for the prediction and increase the speed of the processing.

(8) The collision prediction method according to any one of (1) to (7), wherein
the posture information includes at least one of a position of a tip portion of the robot, an angle of the tip portion of the robot, a position of a joint portion of the robot, or an angle of the joint portion of the robot.

This configuration makes it possible to accurately perform collision prediction on the basis of the specifications of the robot and the real-time state of the robot.

(9) The collision prediction method according to any one of (1) to (8), wherein
the configuration information includes a three-dimensional model indicating a shape of the robot.

This configuration makes it possible to accurately perform collision prediction using a three-dimensional model that supports the specifications of the robot.

(10) A collision prediction device (20, for example) for predicting a collision between a multi-joint robot (10, for example) and a nearby object (50, for example), the collision prediction device including:
a first acquisition unit (301, for example) configured to acquire configuration information of the robot and posture information of the robot;
a second acquisition unit (301, for example) configured to acquire point cloud data including the robot and the nearby object;
a classification unit (305, for example) configured to classify the point cloud data acquired by the second acquisition unit into point cloud data corresponding to the robot and point cloud data corresponding to the nearby object, based on the configuration information of the robot and the posture information of the robot; and
a prediction unit (306, for example) configured to predict a collision between the robot and the nearby object, based on a classification result obtained by the classification unit.

This configuration enables more accurate prediction of a collision between a robot, including an accessory of the robot, and a nearby object.

(11) A welding system (1, for example) including:
the collision prediction device (20, for example) according to (10); and
a welding robot (10, for example), the welding robot including the robot.

This configuration enables more accurate collision prediction for a welding robot, namely, prediction of a collision between the welding robot, including an accessory of the welding robot, and a nearby object.

What is claimed is:

1. A collision prediction method for predicting a collision between a multi-joint robot and a nearby object, the collision prediction method comprising:
a first acquisition step of acquiring configuration information of the robot and posture information of the robot;
a second acquisition step of acquiring point cloud data including the robot and the nearby object;
a classification step of classifying the point cloud data acquired in the second acquisition step into point cloud data corresponding to the robot and point cloud data corresponding to the nearby object, based on the configuration information of the robot and the posture information of the robot; and
a prediction step of predicting a collision between the robot and the nearby object, based on a classification result obtained in the classification step.

2. The collision prediction method according to claim 1, wherein
in the classification step, at least one of a first classification method, a second classification method, a third classification method, or a fourth classification method is executable,
the first classification method being a method of performing clustering on the point cloud data acquired in the second acquisition step and classifying the point cloud data into the point cloud data corresponding to the robot and the point cloud data corresponding to the nearby object, based on a result of the clustering and a position of the robot, the position of the robot being identified by the configuration information and the posture information acquired in the first acquisition step;
the second classification method being a method of acquiring first point cloud data corresponding to the robot from the point cloud data acquired in the second acquisition step by using the first classification method, comparing the first point cloud data with second point cloud data stored in advance, removing, from the first point cloud data, a point cloud for which a shortest distance from the second point cloud data is equal to or less than a predetermined threshold to obtain point cloud data, and classifying the obtained point cloud data as the point cloud data corresponding to the robot,
the third classification method being a method of predicting a position of a tip portion of the robot in the point cloud data acquired in the second acquisition step, based on the configuration information and the posture information, and classifying, as the point cloud data corresponding to the robot, a point cloud corresponding to the tip portion of the robot among point clouds overlapping with a three-dimensional model of the robot when the three-dimensional model of the robot is arranged at the predicted position,
the fourth classification method being a method of acquiring first point cloud data corresponding to the robot from the point cloud data acquired in the second acquisition step by using the first classification method, comparing the first point cloud data with past point cloud data corresponding to the robot and past point cloud data corresponding to the nearby object, and classifying the first point cloud data as closer point cloud data of the past point cloud data corresponding to the robot and the past point cloud data corresponding to the nearby object.

3. The collision prediction method according to claim 2, further comprising a determination step of determining whether the nearby object has moved, wherein
in the classification step, the first classification method is used when it is determined that the nearby object has moved, and the second classification method is used when it is determined that the nearby object has not moved.

4. The collision prediction method according to claim 2, wherein
in the prediction step, at least one of a first prediction method, a second prediction method, or a third prediction method is executable,
the first prediction method being a method of predicting the collision by comparing a shortest distance between the point cloud data corresponding to the robot and the point cloud data corresponding to the nearby object with a predetermined threshold,
the second prediction method being a method of predicting the collision by setting at least one of the point cloud data corresponding to the robot or the point cloud data corresponding to the nearby object as a voxel and determining an overlap, based on the voxel,
the third prediction method being a method of predicting the collision, based on a difference in the number of points between current point cloud data corresponding to the robot and previous point cloud data corresponding to the robot.

5. The collision prediction method according to claim 1, further comprising a preprocessing step of performing predetermined preprocessing on the point cloud data acquired in the second acquisition step, wherein
the predetermined preprocessing includes a process of removing point cloud data located out of a movable range of the robot, and
the classification step classifies the point cloud data on which the predetermined preprocessing is performed in the preprocessing step.

6. The collision prediction method according to claim 1, further comprising an installation step of installing a simulation point cloud for point cloud data classified as the point cloud data corresponding to the robot in the classification step, wherein
the prediction step predicts a collision between the robot and the nearby object by using point cloud data including the simulation point cloud installed in the installation step, and
the simulation point cloud is installed in a straight line connecting a position of a tip of the robot and a position of a joint of the robot or is installed in a predetermined shape with respect to a position corresponding to a predetermined part of the robot.

7. The collision prediction method according to claim 1, further comprising:
a step of acquiring information on a movement direction of a predetermined point on the robot; and
an extraction step of setting a predefined range for the point cloud data corresponding to the robot, the predefined range being defined in advance to extend along a movement direction of the robot with respect to the predetermined point, and extracting point cloud data corresponding to the nearby object within the predefined range, wherein
the prediction step predicts a collision between the robot and the nearby object by using the point cloud data corresponding to the nearby object extracted in the extraction step and the point cloud data corresponding to the robot.

8. The collision prediction method according to claim 1, wherein
the posture information includes at least one of a position of a tip portion of the robot, an angle of the tip portion of the robot, a position of a joint portion of the robot, or an angle of the joint portion of the robot.

9. The collision prediction method according to claim 1, wherein
the configuration information includes a three-dimensional model indicating a shape of the robot.

10. A collision prediction device for predicting a collision between a multi-joint robot and a nearby object, the collision prediction device comprising:
a first acquisition unit configured to acquire configuration information of the robot and posture information of the robot;
a second acquisition unit configured to acquire point cloud data including the robot and the nearby object;
a classification unit configured to classify the point cloud data acquired by the second acquisition unit into point cloud data corresponding to the robot and point cloud data corresponding to the nearby object, based on the configuration information of the robot and the posture information of the robot; and
a prediction unit configured to predict a collision between the robot and the nearby object, based on a classification result obtained by the classification unit.

11. A welding system comprising:
the collision prediction device according to claim 10; and
a welding robot, the welding robot comprising the robot.
